(19) United States
(12) Patent Application Publication
(10) Pub. No.: US 2007/0222287 A1
(43) Pub. Date: Sep. 27, 2007

(54) AUTOMOTIVE REGENERATIVE AND FRICTION BRAKING SYSTEM AND CONTROL METHOD

(75) Inventors: Dale Crombez, Livonia, MI (US); Matt Smith, Dearborn Heights, MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/308,413

(22) Filed: Mar. 22, 2006

(51) Int. Cl. B60T 8/64

(52) U.S. Cl. 303/151; 303/152

(57) ABSTRACT

An automotive regenerative and friction braking system uses a separate brake system control module and a powertrain control module. The brake system control module normally operates the friction and regenerative brakes in a coordinated, or series, configuration. In the event that the brake system control module becomes inoperative, the powertrain control module will operate the regenerative braking system in a parallel, or independent, configuration.

### BACKGROUND OF THE INVENTION

The present invention relates to an automotive vehicle having both a friction braking subsystem and a regenerative braking subsystem, as well as at least one software-based controller for running the braking subsystems in a series configuration during normal operation, and in a parallel configuration in the event that a brake system controller becomes inoperative.

Vehicles having either full or partial electrodrive capability, such as purely battery powered vehicles on the first hand, and hybrid gasoline-electric vehicles on the other hand, typically utilize regenerative braking as a principal means for enhancing vehicle fuel economy. Regenerative braking is almost always combined with friction braking, because regenerative braking is usually not adequate for all situations, for a host of reasons.

A principle reason militating in favor of supplementing regenerative braking with friction braking exists because regenerative brakes are usually not available on all of the wheels of a vehicle. This is simply due to the fact that motor drives are usually applied to only one axle of a vehicle. On the other hand, friction brakes are readily applied to all the wheels of the vehicle. A second reason limiting the capability of regenerative brakes deals with the need to store energy. Thus, if a battery is fully charged, the regenerative system cannot be employed unless a resistance load bank is incorporated within the vehicle at added cost, weight, complexity and thermodynamic load. Also, regenerative braking in some modes is limited by the status of the heat build within the traction motor.

Vehicles having regenerative friction braking subsystems may be operated either as a parallel system, in which both the friction and regenerative brakes are applied simultaneously, or as a series system, in which regenerative brakes are applied first, followed by friction braking to fill in the required braking amount. The term “coordinated braking” is sometimes used to refer to series braking. In general, parallel braking systems are less expensive, but suffer from inferior brake pedal feel, including inconsistent brake pedal feel. Parallel systems also offer a lesser fuel economy improvement than do series braking systems. Series braking systems on the other hand, offer, albeit at a higher price, a better, more consistent, pedal feel and more regenerative capability, which yields a higher fuel economy improvement. In addition, series systems require coordinated braking control between the friction brake actuator controllers(s) and the powertrain actuator controller(s).

Vehicle systems designers have attempted to provide controls to prevent lock up of driving wheels due to regenerative braking system operation, as well as control of regenerative and friction braking systems so as to present a transparent operating characteristic to the operator of a vehicle. U.S. Pat. No. 6,724,165 and U.S. Pat. No. 6,655,754 illustrate typical regenerative braking systems.

The present invention deals with an issue tied to the use of braking systems having regenerative and friction subsystems. Namely, in the event that the controller required for the coordination of the friction brakes and the regenerative brakes becomes inoperative, regenerative braking becomes unavailable. Such inoperativeness could be due to loss of a communication link between controllers of the friction brake subsystem and the powertrain control module, or for a variety of system fault reasons. The present system operates friction braking and regenerative braking subsystems in a parallel fashion using only a powertrain control module to operate the regenerative braking in the event that a brake system control module becomes inoperative.

### SUMMARY OF THE INVENTION

An automotive regenerative and friction braking system includes a friction braking subsystem having at least one power absorber and a plurality of braking system sensors. A brake system control module operates the friction braking subsystem. A regenerative braking subsystem is operated by at least one powertrain control module which is operatively connected with the brake system control module. The powertrain control module operates the regenerative braking system according to commands including at least one command, or other information, from the brake system control module. A software routine sited within the powertrain control module operates the regenerative braking subsystem in parallel with the friction braking subsystem in the event that either coordinated braking becomes inoperative, or the brake system control module exhibits degraded control over friction braking. Those skilled in the art will appreciate in view of this disclosure that a powertrain module useful for practicing the present invention could comprise either a traditional powertrain control module for controlling operating parameters such as fuel delivery, spark timing, gear selection, torque converter lockup and other variables, or an engine torque and brake controller primarily used for other purposes, such as an adaptive cruise control module.

The software routine within the powertrain control module uses an output of at least one braking parameter sensor to control the regenerative braking subsystem in the event that the brake system control module becomes inoperative. The sensor output used by the software routine may include output from a motorist-controlled device such as a brake pedal switch, a brake pedal position sensor, or a friction braking system pressure sensor.

According to another aspect of the present invention, a method for operating an automotive regenerative and friction braking system includes the steps of normally operating a friction braking subsystem and a regenerative braking subsystem in a series configuration using a brake system control module and a powertrain control module. The friction braking subsystem and the regenerative braking subsystem are operated in a parallel configuration under the sole control of a control module independent of the brake module, such as a powertrain control module, in the event that the brake system control module is inoperative. The powertrain control module receives input from a plurality of vehicle sensors including at least a braking parameter sensor.

In addition to operating at least one traction motor attached to an associated traction battery, a powertrain control module according to present invention may also operate an internal combustion engine shown at 40 in FIG. 1.

It is an advantage of a method and system according to the present invention that regenerative braking may be maintained on a vehicle having both regenerative and friction braking capability, even if coordinated braking becomes inoperative or the brake system control module exhibits an indication of degraded friction braking performance capability.

It is a further advantage of a method and system according to the present invention that a vehicle operating according to this method will maintain regenerative operation at a safe level notwithstanding the absence of an effective brake system controller.

It is yet another advantage of a method and system according to the present invention that a redundant braking system is provided, so as to increase the availability of braking notwithstanding control system malfunctions.

Other advantages, as well as features and objects of the present invention, will become apparent to the reader of this specification.

### BRIEF DESCRIPTION OF THE DRAWINGS

FIG. 1 is a block diagram of a regenerative and friction braking system according to the present invention.

FIG. 2 is a flow chart illustrating a control method according to one aspect of the present invention.

### DETAILED DESCRIPTION OF THE PREFERRED EMBODIMENTS

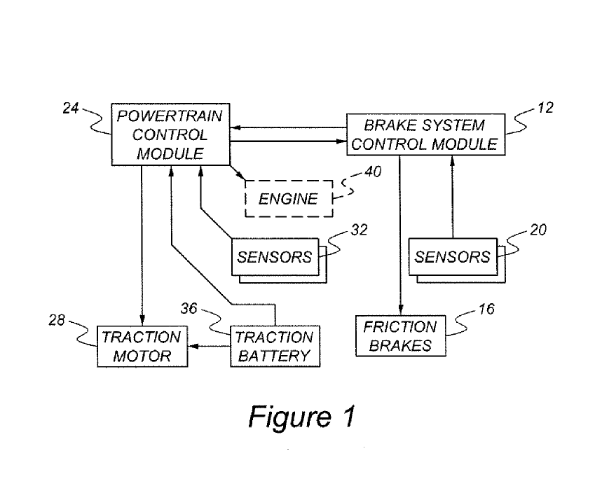

As shown in FIG. 1, an automotive regenerative and friction braking system includes a friction braking subsystem having a number of friction brakes, 16, which may be of the disk or drum type or yet other types of friction brakes known to those skilled in the art and suggested by this disclosure. The friction braking subsystem also includes a number of brake parameter sensors, 20, such as a brake pedal position sensor, or a brake system hydraulic pressure sensor, or a brake pedal pressure sensor, or a brake pedal movement sensor. All of sensors 20 and friction brakes 16 are operatively connected brake system control module 12, which performs a function of coordinating controlling the overall braking of the vehicle. Brake system control module 12 normally operates the friction and regenerative braking subsystems in a series configuration.

Brake system control module 12 communicates with powertrain control module 24, which is operatively connected with traction motor 28, traction battery 36, and a plurality of sensors, 32. The functions of brake system control module 12 and powertrain control module 24 may be housed within any control module(s) which coordinate brake control between the regenerative and friction braking subsystems. Thus, one of the duties of powertrain control module 24 is to function as a regenerative control module. This duty could be handled by another control module, such as a freestanding, dedicated regenerative controller. This detail is consigned to those wishing to employ the present invention.

At least some of sensors 20 may be the same as sensors 32. In other words, the sensors are shared by the regenerative and friction braking subsystems. The regenerative braking subsystem includes at least traction motor 28 and traction battery 36. Powertrain control module 24 operates in response to commands from brake system control module 12 during normal, or series, operation of the present regenerative and friction braking system. In the event that brake system control module 12 exhibits an indication of degraded brake system control capability, or if communication is lost between brake system control module 12 and powertrain control module 24, such as because of a wiring fault, or if brake system control module 12 ceases to function, powertrain control module 24 will initiate operation of the braking system in a parallel function. In essence, a software routine sited within powertrain control module 24 operates the regenerative braking subsystem in parallel with the friction braking subsystem.

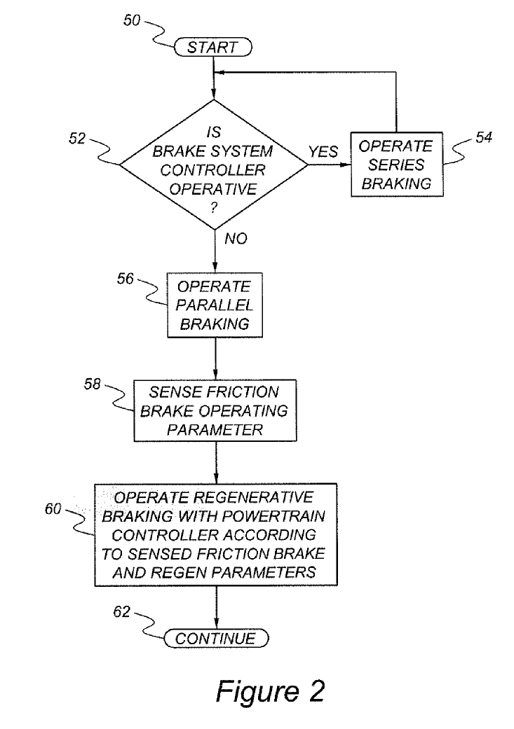

Operation of the present system in a parallel mode is facilitated by at least one braking parameter sensor which may or may not be shared by the friction and regenerative braking subsystems. Such a sensor, which preferably comprises a brake pedal position sensor, or a brake system pressure sensor, both of which may be included in sensor groups 20 and 32, produces a signal which is indicative of the extent to which a motorist has either depressed a brake pedal in a vehicle, or otherwise requested braking, such as by activating a retarder switch. This information is communicated to powertrain control module 24, which uses the information as an indication of the extent to which the regenerative braking subsystem should be applied. This is shown in FIG. 2, wherein the operation of system begins at block 50 and continues at block 52, where a question is asked regarding whether the brake system controller, in this case control module 12, is operative. For the purposes of this specification, the term “operative” means that a control module is functioning so as to satisfy design intent. Thus, if module 12 is either not communicating at all with powertrain control module 24, or is exhibiting signs of an inability to properly control the braking system, module 12 will be said to be “inoperative”.

If module 12 is operative at block 52, the system operates according to series braking rules at block 54. If, however, brake system control module 12 is not operative, the routine moves to block 56.

At block 56 the controller gives a command to operate according to parallel braking rules. Then, at block 58 at least one friction brake operating parameter is sensed and at block 60, the value of this operating parameter is used by powertrain control module 24 to operate the regenerative braking system. Then, the routine continues at block 62.

When the present braking system is being operated by powertrain control module 24, a true parallel system is in operation, because the brake line hydraulic pressure created by a motorist pressing on the brake pedal is allowed to flow through to at least one of friction brakes 16, while powertrain control module 24 simultaneously provides control of the regenerative braking system. A shared or independent sensor feature, as described above, allows the powertrain control module to use brake pedal position as an input variable.

Although the present invention has been described in connection with particular embodiments thereof, it is to be understood that various modifications, alterations, and adaptations may be made by those skilled in the art without departing from the spirit and scope of the invention set forth in the following claims.

What is claimed is:

1. An automotive regenerative and friction braking system, comprising:
a friction braking subsystem comprising at least one power absorber and a plurality of braking parameter sensors;
a brake system control module for operating said friction braking subsystem;
a regenerative braking subsystem;
a regenerative control module, operatively connected with said brake system control module, for operating said regenerative braking subsystem according to a plurality of signals, comprising at least one signal from said brake system control module; and
a software routine, associated with said regenerative control module, for operating said regenerative braking subsystem in parallel with said friction braking subsystem in the event that said brake system control module becomes inoperative.

2. An automotive regenerative and friction braking system according to claim 1, wherein said software routine uses an output of at least one of said braking parameter sensors to control said regenerative braking subsystem in the event that said brake system control module becomes inoperative.

3. An automotive regenerative and friction braking system according to claim 2, wherein said software routine uses an output from a motorist-controlled device to control said regenerative braking subsystem.

4. An automotive regenerative and friction braking system according to claim 3, wherein said software routine uses an output from a brake pedal switch.

5. An automotive regenerative and friction braking system according to claim 3, wherein said software routine uses an output from a brake pedal position sensor.

6. An automotive regenerative and friction braking system according to claim 3, wherein said software routine uses an output from a friction braking system pressure sensor.

7. An automotive regenerative and friction braking system according to claim 3, wherein said software routine uses an output from a brake pedal force sensor.

8. An automotive regenerative and friction braking system according to claim 1, wherein said software is sited within said regenerative control module.

9. An automotive regenerative and friction braking system according to claim 1, wherein said regenerative control module comprises a powertrain control module.

10. A method for operating an automotive regenerative and friction braking system, comprising the steps of:
normally operating a friction braking subsystem and a regenerative braking subsystem in a series configuration, using a brake system control module and a powertrain control module;
operating said regenerative braking subsystem in a parallel configuration under sole control of the powertrain control module in the event that the brake system control module is inoperative.

11. A method according to claim 10, wherein said powertrain control module receives inputs from a plurality of vehicle sensors, including at least a braking parameter sensor.

12. A method according to claim 11, wherein said braking parameter sensor comprises a brake pedal position sensor.

13. A method according to claim 11, wherein said braking parameter sensor comprises a brake retarder switch.

14. A method according to claim 10, wherein the amount of regenerative braking applied by said powertrain control module is a function of a plurality of vehicle operating parameters.

15. A method according to claim 10, wherein the amount of regenerative braking applied by the powertrain control module is a function of at least the state of charge of a traction battery associated with said regenerative braking subsystem.

16. A method according to claim 10, wherein the amount of regenerative braking applied by the powertrain control module is controlled so as to minimize variations in the transfer function relating brake pedal position and brake torque.

17. An automotive regenerative and friction braking system, comprising:
a friction braking subsystem comprising a brake pedal, a plurality of friction brakes and at least one brake parameter sensor;
a brake system control module for operating said friction braking subsystem;
a regenerative braking subsystem comprising at least one traction motor and an associated traction battery;
a powertrain control module, operatively connected with said brake system control module, for operating said regenerative braking subsystem according to a plurality of signals comprising at least one signal from said brake system control module; and
a software routine, sited within said powertrain control module, for operating said regenerative braking subsystem in parallel with said friction braking subsystem in the event that said brake system control module becomes inoperative, with said software routine using output from said brake parameter sensor.

18. An automotive regenerative and friction braking system, according to claim 17, wherein said at least one brake parameter sensor comprises a brake pedal position sensor.

19. An automotive regenerative and friction braking system, according to claim 17, wherein said at least one brake parameter sensor comprises a brake system pressure sensor.

20. An automotive regenerative and friction braking system, according to claim 17, wherein said at least one brake parameter sensor comprises a brake pedal force sensor.

21. An automotive regenerative and friction braking system according to claim 17, wherein said powertrain controller operates not only a traction motor, but also an internal combustion engine.

22. An automotive regenerative and friction braking system according to claim 17, wherein said brake system control module normally operates said friction braking subsystem and said regenerative braking subsystem in series.
